(19) United States
(12) Patent Application Publication
(10) Pub. No.: US 2020/0252480 A1
(43) Pub. Date: Aug. 6, 2020

(54) METHOD AND SYSTEM FOR PROVIDING A RECOMMENDED DIGITAL CONTENT ITEM

(71) Applicant: YANDEX EUROPE AG, Luzern, CH (US)

(72) Inventors: Marina Evgenievna SURYGINA, Moscow (RU); Nikita Anatolievich FOMINOV, Moscow (RU); Vitalii Sergeevich KOCHUROV, Moscow (RU); Aleksandr Igorevich KOZHEVNIKOV, Ekaterinburg (RU); Andrey Alekseevich SHESTIMEROV, Moscow (RU); Vasily Valentinovich MIKHAYLOV, Moscow (RU); Mariya Vasilievna FILINA, Moscow (RU)

(21) Appl. No.: 16/739,668

(22) Filed: Jan. 10, 2020

(30) Foreign Application Priority Data
Feb. 6, 2019 (RU) 2019103257

(51) Int. Cl. H04L 29/08

(52) U.S. Cl. CPC H04L 67/306; H04L 67/18

(57) ABSTRACT

A method and a system for providing a recommended content item is disclosed to an electronic device. The method comprises displaying a first digital content item on a digital content display; and receiving data indicative of a movement of the electronic device. Based on the data, generating a geo-track associated with the electronic device. Based on the geo-track and an exposure perimeter of the digital content display, determining a likelihood parameter indicative of the user having been exposed to the first digital content item. In response to the likelihood parameter being above a threshold, verifying if a topic of the first digital content item is aligned with a user profile associated with the user stored in the online user profile database. In the affirmative, selecting a second digital content item sharing the topic of the first digital content item and transmitting the second digital content item to the electronic device.

### CROSS-REFERENCE

The present application claims priority to Russian Patent Application No. 2019103257, entitled “METHOD AND SYSTEM FOR PROVIDING A RECOMMENDED DIGITAL CONTENT ITEM,” filed on Feb. 6, 2019, the entirety of which is incorporated herein by reference.

### FIELD

The present technology relates to recommendation systems in general and specifically to a method and a system for providing a recommended digital content item to an electronic device associated with a user.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment-related information. Users use a variety of client devices (desktop, laptop, notebook, smartphone, tablets and the like) to have access to rich content (like images, audio, video, animation, and other multimedia content from such networks).

When a typical user browses the Internet, the user gets exposed to this multitude of information—be it on a form of content that the user is searching for (for example, using a search engine or a content recommendation system) or by various personalized/targeted content systems.

Conventionally, efforts have been focused on providing personalized content items based on the online activities of a user. For example, if the user searches for new cars, a personalized targeted message about a new promotion (such as preferred financing rates) can be provided to the user (as a side bar, pop up window, an overlaid video and the like). Needless to say, not only it is difficult to properly assess user interests based solely on online activities, the conventional approach neglects to consider what the user might have been exposed in an offline setting.

United States Patent Application Publication No. 2015/0348119 A1 published on Dec. 3, 2015 to Videology Inc., and titled “Method and System for Targeted Advertising Based on Associated Online and Offline User Behaviors” teaches methods, systems, and programming for targeted advertising and conversion measurement. In one example, first information related to an online activity of a user is received. The online activity is associated with a first attribute to be used to identify the user. Second information related to an offline activity of the user is received. The offline activity is associated with a second attribute to be used to identify the user. A connection between the online activity and the offline activity of the user is then identified by matching the first attribute with the second attribute. A profile of the user is obtained based, at least in part, on the identified connection. A request of serving an advertisement is received. The user is selected from a plurality of users based on the profile of the user and information related to the request. The advertisement is provided to the user.

United States Patent Application Publication No. 2010/262456 A1 published Oct. 14, 2010 to Yahoo! Inc., and titled “System and Method for Deep Targeting Advertisement Based on Social behaviors” teaches a method and system to display a targeted online advertisement to a targeted online user based on offline behavior profiles. The method include techniques for identifying offline behavior aspects of the online user through a variety of databases, including databases of physical sites visited, databases of transactions and amounts, databases pertaining to retail loyalty cards and databases hosting occurrence of real world events. Techniques employed for codifying offline behavior include classifying behavior into categories or groups, categorizing behavior by location of an event, size of expenditure, nature of event, frequency of event, and/or periodicity of event. Having established some codified offline behavior of the online user, the system proceeds by correlating some aspect of user's offline behavior to some aspect of an online advertisement. Given the correlation between the user's offline behavior and the targeting characteristics of the advertisement, the advertisement is optionally customized and displayed to the targeted user

United States Patent Application Publication No. 2013/0246173 A1 published Sep. 19, 2013 to Responsys Inc., and titled “System and Method for Delivering Online Advertisements” teaches an ad orchestration server that selects and sequences the delivery of ads based on multiple offline and online conditions. The ad orchestration server takes into account messages a user might have seen from the advertiser online which the ad server knows about through its tracking cookie, as well as other data about the user that is obtained using offline and other online methods.

### SUMMARY

It is an object of the present technology to provide improved method and systems for providing recommended digital content item.

Non-limiting embodiments of the present technology have been developed based on developers' appreciation of at least one problem associated with the prior art approaches.

Whether by navigating on the Internet, or driving on a road, a given user is exposed to a plurality of digital content items. It is thus desirable to determine what type of digital content item has been found to have caught the eye of the user, and use that information when selecting a digital content item for display in an online setting.

For example, let us assume that a given user has been to a sportswear shop in which he has been exposed to a new baseball mitt advertisement, thereby showing an interest to baseball goods. It would thus be desirable to display baseball related advertisements in an online setting to the same user. By selecting digital content items for display on an online setting based on what the user has been exposed to in an offline setting, not only user satisfaction will be increased, but it would also prevent less interesting digital content items to be displayed, thereby efficiently using computational power when selecting digital content items.

Without wishing to be bound to any specific theory, embodiments of the present technology have been developed based on a premise that people often carry electronic devices (e.g. mobile phones) that are configured to collect their positions as they travel. By analyzing the travelled positions, it is possible to predict how likely a user has been exposed to an offline content item. Based on the determination of whether a user has seen the offline content item or not, it would be then possible to update the online user profile, and thereby create a more comprehensive user profile.

In accordance with a first broad aspect of the present technology, there is provided a computer-implemented method for providing a recommended content item to an electronic device associated with a user, the electronic device having a geo-sensor. The method is executed by a server coupled to an online user profile database maintaining one or more online user profiles of one or more users associated with one or more services; a user-independent digital content display having an exposure perimeter; a content item database comprising a plurality of digital content items. The method comprises: causing the user-independent digital content display, to display a first digital content item from the content item database, the first digital content item not being personalized for the user; receiving, from the electronic device, data indicative of the electronic device movement, the data having been captured by the geo-sensor; based on the data, generating a geo-track associated with the electronic device; determining based on the geo-track and the exposure perimeter, a likelihood parameter indicative of the user having been exposed to the first digital content item being displayed by the user-independent digital content display; in response to the likelihood parameter being above a pre-determined threshold, verifying if a topic of the first digital content item is aligned with a user profile associated with the user stored in the online user profile database; in response to the topic of the first digital content item being aligned with the user profile, selecting a second digital content item, the second digital content item sharing the topic of the first digital content item; and transmitting the second digital content item to the electronic device associated with the user.

In some non-limiting embodiments of the method, the user-independent digital content display comprises at least one sensor, and wherein the likelihood parameter is further based on the at least one sensor detecting the electronic device being within the exposure perimeter.

In some non-limiting embodiments of the method, the at least one sensor is configured to detect a unique device identifier and a signal strength associated with the electronic device.

In some non-limiting embodiments of the method, the geo-sensor is a GPS sensor, and wherein the likelihood parameter is further based on a GPS-based position of the GPS sensor being within the exposure perimeter.

In some non-limiting embodiments of the method, the geo-track comprises a trajectory and dwelling intervals associated with movement of the electronic device, and wherein the likelihood parameter is further based on at least one of: the trajectory intersecting the exposure perimeter; the dwelling intervals being proximate to the exposure perimeter.

In some non-limiting embodiments of the method, the likelihood parameter being above the pre-determined threshold in response to the dwelling intervals being above a pre-determined duration.

In some non-limiting embodiments of the method, the electronic device comprises a user ID and wherein the method further comprises acquiring the user profile based on the user ID.

In some non-limiting embodiments of the method, the electronic device comprises a device ID and wherein the method further comprises correlating the device ID with a user ID, and acquiring the user profile based on the user ID.

In some non-limiting embodiments of the method, the user-independent digital content display further comprises a camera; and wherein the method further comprises: receiving, the user-independent digital content display, a captured image of the user; correlating the captured image to the user profile.

In some non-limiting embodiments of the method, the correlating the captured image to the user profile comprises: accessing the one or more web services; matching the captured image with digital images contained in open pages associated with the user.

In some non-limiting embodiments of the method, the user-independent digital content display is one an electronic billboard and an electronic screen.

In some non-limiting embodiments of the method, the receiving, from the electronic device, data indicative of the electronic device movement, the data having been captured by the geo-sensor comprises: receiving data from multiple electronic devices; correlating data from multiple electronic devices to the user based on geo information from the multiple electronic devices being aligned over a pre-determined period of time.

In accordance with another broad aspect of the present technology, there is provided a system for providing a recommended content item to an electronic device associated with a user, the electronic device having a geo-sensor. The system comprises server connectable to: an online user profile database maintaining one or more online user profiles of one or more users associated with one or more services; a user-independent digital content display having an exposure perimeter; a content item database comprising a plurality of digital content items. The server comprises a processor configured to: cause the user-independent digital content display, to display a first digital content item from the content item database, the first digital content item not being personalized for the user; receive, from the electronic device, data indicative of the electronic device movement, the data having been captured by the geo-sensor; based on the data, generate a geo-track associated with the electronic device; determine based on the geo-track and the exposure perimeter, a likelihood parameter indicative of the user having been exposed to the first digital content item being displayed by the user-independent digital content display; in response to the likelihood parameter being above a pre-determined threshold, verify if a topic of the first digital content item is aligned with a user profile associated with the user stored in the online user profile database; in response to the topic of the first digital content item being aligned with the user profile, select a second digital content item, the second digital content item sharing the topic of the first digital content item; and transmit the second digital content item to the electronic device associated with the user.

In some non-limiting embodiments of the system, the user-independent digital content display comprises at least one sensor, and wherein the likelihood parameter is further based on the at least one sensor detecting the electronic device being within the exposure perimeter.

In some non-limiting embodiments of the system, the at least one sensor is configured to detect a unique device identifier and a signal strength associated with the electronic device.

In some non-limiting embodiments of the system, the geo-sensor is a GPS sensor, and wherein the likelihood parameter is further based on a GPS-based position of the GPS sensor being within the exposure perimeter.

In some non-limiting embodiments of the system, the geo-track comprises a trajectory and dwelling intervals associated with movement of the electronic device, and wherein the likelihood parameter is further based on at least one of: the trajectory intersecting the exposure perimeter; the dwelling intervals being proximate to the exposure perimeter.

In some non-limiting embodiments of the system, the likelihood parameter being above the pre-determined threshold in response to the dwelling intervals being above a pre-determined duration.

In some non-limiting embodiments of the system, the electronic device comprises a user ID and wherein the processor is further configured to acquire the user profile based on the user ID.

In some non-limiting embodiments of the system, the user-independent digital content display further comprises a camera; and wherein the processor is further configured to: receive, the user-independent digital content display, a captured image of the user; correlate the captured image to the user profile.

In some non-limiting embodiments of the system, in order to correlate the captured image to the user profile, the processor is configured to: access the one or more web services; match the captured image with digital images contained in open pages associated with the user.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology.

FIG. 2 depicts a schematic illustration of a navigation log associated with an electronic device of the system of FIG. 1.

FIG. 3 depicts a schematic illustration of the digital content item database of the system of FIG. 1.

FIG. 4 depicts a schematic diagram of generating an aggregated user profile.

FIG. 5 depicts a content display device installed in a proximity to a road, this being an example of an outdoor content display device.

FIG. 6 depicts two content display devices installed within a building, these being examples of an indoor content display device.

FIG. 7 depicts an example process for selecting a content item.

FIG. 8 depicts a schematic diagram of a process for augmenting a user navigation history and tracking an electronic device.

FIG. 9 depicts a block diagram of a flow chart of a method for providing recommended digital content item.

### DETAILED DESCRIPTION

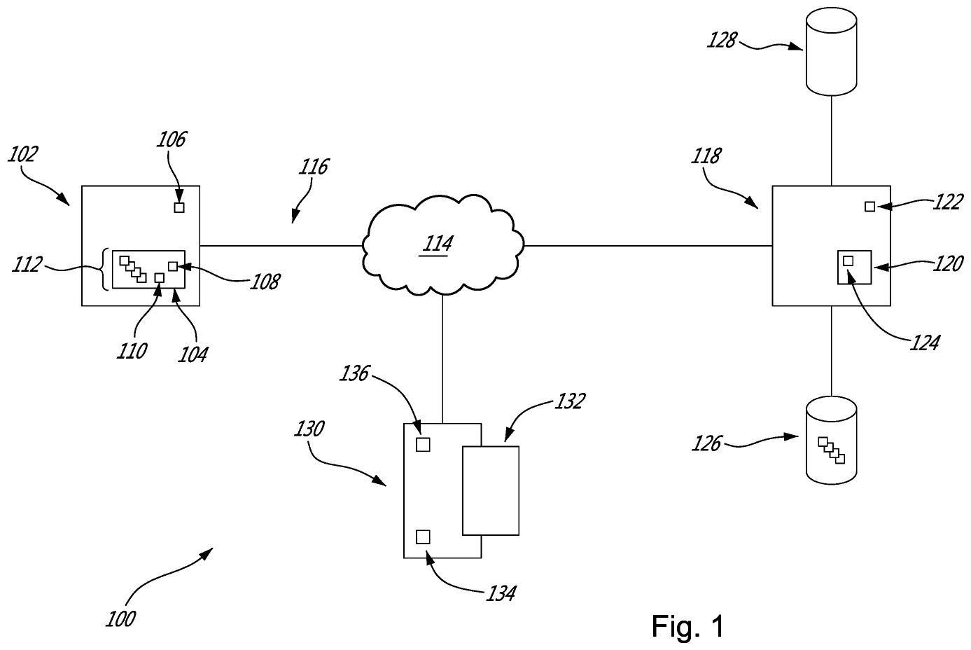

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises an electronic device 102. The electronic device 102 is typically associated with a user (not depicted) and, as such, can sometimes be referred to as a “client device”. It should be noted that the fact that the electronic device 102 is associated with the user does not mean to suggest or imply any mode of operation—such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 comprises a permanent storage 104. The permanent storage 104 may encompass one or more storage media and generally provides a place to store computer-executable instructions executable by a processor 106. By way of an example, the permanent storage 104 may be implemented as a computer-readable storage medium including Read-Only Memory (ROM), hard disk drives (HDDs), solid-state drives (SSDs), and flash-memory cards.

The electronic device 102 comprises hardware and/or software and/or firmware (or a combination thereof) to execute a navigation application 108. Generally speaking, the purpose of the navigation application 108 is to enable the user to navigate from a given location to another location. The manner in which the navigation application 108 is implemented is known in the art and will not be described herein. Suffice to say that the navigation application 108 may be one of Yandex.Maps™, Yandex.Navigator™, or other commercial or proprietary navigation applications.

Irrespective of how the navigation application 108 is implemented, the navigation application 108 has access to a GPS receiver configured to receive GPS satellite signals and determine the position of the electronic device 102. Generally speaking, the electronic device 102 does not need to be connected to the Internet, nor be executing the navigation application 108, to receive the GPS satellite signals, and as such the electronic device 102 may be configured to track the movement of a user in the form of latitude and longitude irrespective of the availability of the Internet connection.

In some non-limiting embodiments, the electronic device 102 comprises a navigation log 110, which stores the GPS coordinates that have been collected during a time period when the navigation application 108 is active. In some non-limiting embodiments, the navigation log 110 may further host the GPS coordinates that have been collected while the navigation application 108 is not in-use.

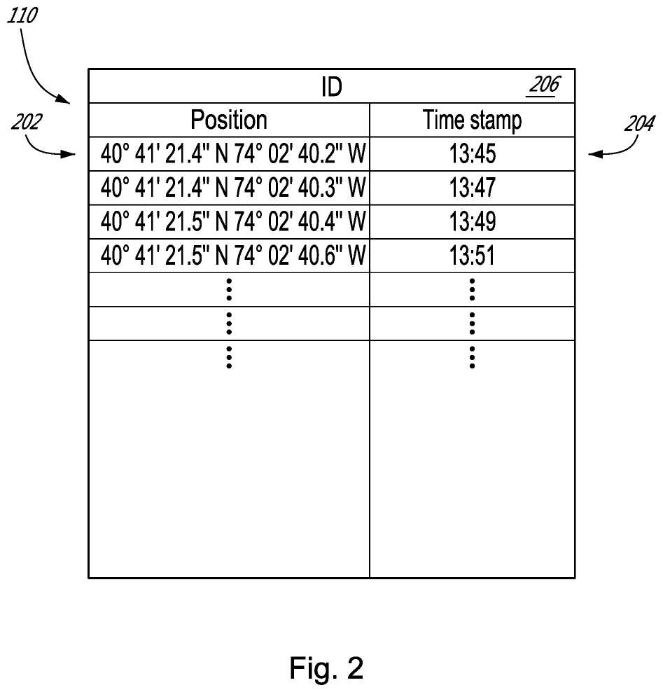

With reference to FIG. 2, a non-limiting embodiment of the navigation log 110 is illustrated. The manner in which the navigation log 110 is populated is not limited. Just as an example, the navigation application 108 may be configured to receive the GPS satellite signals at predetermined time intervals, and convert the GPS satellite into GPS coordinates.

The navigation log 110 stores a first GPS coordinate 202 which corresponds to the location of the Statue of Liberty. The first GPS coordinate 202 is associated with a first timestamp 204. The first timestamp 204 corresponds to the time at which the electronic device 102 was at the first GPS coordinate 202.

The navigation log 110 further stores a plurality of GPS coordinates and associated time stamps (not separately numbered). For example, based on the time stamps and GPS coordinates within the navigation log 110, it should be understood that the electronic device 102 has moved 0.5 seconds north and 0.4 seconds west within 6 minutes. Although only four GPS positions are illustrated in the navigation log 110, it should be understood that the navigation log 110 may store more or fewer than four GPS positions.

In some non-limiting embodiments, the navigation application 108 is configured to assign a user device ID 206 to the navigation log 110. For example, the user device ID 206 may correspond to a proprietary ID number assigned by the navigation application 108 as well as other related one or more service applications 112 (described below). In some non-limiting embodiments, the navigation log 110 may further be associated with a user ID (not shown), which may correspond to a user name (such as an email address) associated with the user if the navigation application 108 requires signing-in.

Referring back to FIG. 1, the electronic device 102 comprises hardware and/or software and/or firmware (or a combination thereof) to execute one or more service applications 112. Generally speaking, the one or more service applications 112 correspond to electronic applications accessible by the electronic device 102. In some non-limiting embodiments, the one or more service applications 112 comprise at least one service application (not numbered) that is operated by the same entity that has provided the afore-described navigation application 108. For example, if the navigation application 108 is Yandex.Navigator™, the one or more service applications 112 may include a web browser application Yandex.Browser™, a news application Yandex.News™, a market application Yandex.Market™, and the like. Needless to say, the one or more service applications 112 may also include service applications that are not operated by the same entity that has provided the afore-mentioned navigation application 108, and may comprise for example, social media applications such as Vkontakte™, and music streaming application such as Spotify™.

In some non-limiting embodiments the activities of the user executed on each of the one or more service applications 112 are collected by one or more associated web server (not shown), and are used to build a profile of the user associated with the electronic device 102. In some non-limiting embodiments, the one or more service applications 112 that are operated by the same entity as the navigation application 108 are configured to store the collected activities with an indication of the user device ID 206.

The electronic device 102 comprises a communication interface (not depicted) for enabling two-way communication with a communication network 114 via a communication link 116. In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link 116 is implemented is not particularly limited and depends on how the electronic device 102 is implemented. Merely as an example and not as a limitation, in those embodiments of the present technology where the electronic device 102 is implemented as a wireless communication device (such as a smart phone), the communication link 116 can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the electronic device 102, the communication link 116 and the communication network 114 are provided for illustration purposes only. As such, those skilled in the art will easily appreciate other specific implementational details for the electronic device 102, the communication link 116, and the communication network 114. As such, by no means the examples provided hereinabove are meant to limit the scope of the present technology.

The system 100 further includes a server 118 coupled to the communication network 114. The server 118 can be implemented as a computer server. In an example of an embodiment of the present technology, the server 118 can be implemented as a Dell™ PowerEdge™ Server running the Microsoft™ Windows Server™ operating system. Needless to say, the server 118 can be implemented in any other suitable hardware and/or software and/or firmware or a combination thereof. In the depicted non-limiting embodiment of the present technology, the server 118 is a single server. In alternative non-limiting embodiments of the present technology, the functionality of the server 118 may be distributed and may be implemented via multiple servers.

The server 118 comprises a communication interface (not depicted) structured and configured to communicate with various entities (such as the electronic device 102 and other devices potentially coupled to the communication network 114) via the communication network 114. The server 118 comprises a server memory 120 which comprises one or more storage media and generally provides a place to store computer-executable program instructions executable by a server processor 122. By way of example, the server memory 120 may be implemented as a tangible computer-readable storage medium including Read-Only Memory (ROM) and/or Random-Access Memory (RAM). The server memory 120 may also include one or more fixed storage devices in the form of, by way of example, hard disk drives (HDDs), solid-state drives (SSDs), and flash-memory cards.

In some non-limiting embodiments, the server 118 can be operated by the same entity that has provided the afore-described navigation application 108. For example, if the navigation application 108 is a Yandex.Navigator™, the server 118 can be operated by Yandex LLC of Lev Tolstoy Street, No. 16, Moscow, 119021, Russia. In alternative embodiments, the server 118 can be operated by an entity different from the one that has provided the aforementioned navigation application 108.

In accordance with the non-limiting embodiments of the present technology, the server 118 is configured to execute a digital content item selection application 124 (the “selection application 124”). The manner in which the selection application 124 is implemented is described in detail below.

To that end, the server 118 is communicatively coupled to a digital content item database 126. In alternative embodiments, the digital content item database 126 may be communicatively coupled to the server 118 via the communication network 114. Although the digital content item database 126 is illustrated schematically herein as a single entity, it is contemplated that the digital content item database 126 may be configured in a distributed manner.

The digital content item database 126 is populated with a plurality of digital content items (not separately numbered). The nature of each of the plurality of digital content item is not particularly limited. Broadly speaking, a digital content item may correspond to an advertisement, comprising one or more sentences, images, videos, etc.

### Digital Content Item Database 126

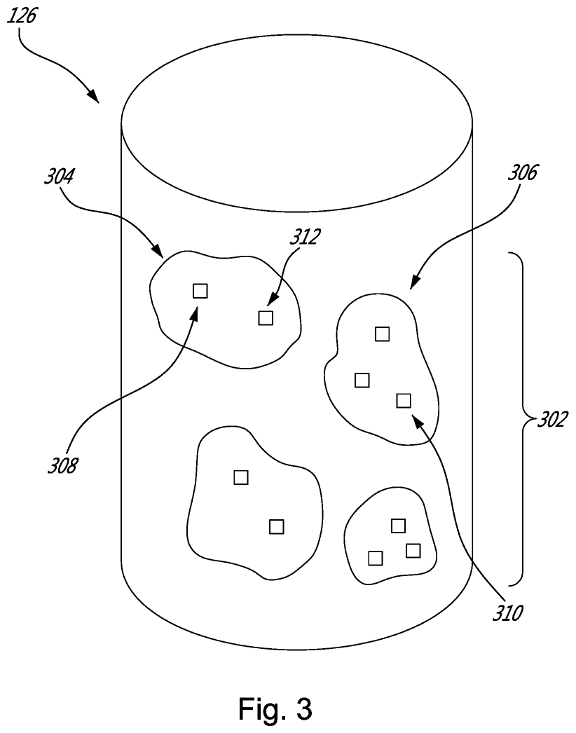

With reference to FIG. 3, a non-limiting embodiment of the digital content item database 126 populated with the plurality of digital content item is illustrated.

The manner in which the digital content item database 126 is populated is not limited. Just as an example the digital content item database 126 may receive the digital content items from one or more advertisers.

The digital content item database 126 stores the plurality of digital content items clustered into one or more topics. As such, the digital content item database 126 is configured to execute a topic clustering routine (not depicted). The manner in which the plurality of digital content items are clustered into one or more topics or events is not limited, and may for example, be done using conventional clustering techniques, such as topic modelling or key words-based approaches.

The plurality of digital content items is clustered into one or more topic clusters 302. For example, the digital content item database 126 stores a first topic cluster 304, a second topic cluster 306, a third topic cluster (not numbered) and a fourth topic cluster (not numbered). The first topic cluster 304 includes a first digital content item 308 and a second digital content item 312, and the second topic cluster 306 includes a third digital content item 310.

In some non-limiting embodiments of the present technology, the digital content item database 126 comprises additional information in respect to each of the plurality of digital content items, such as the duration of the digital content item, a minimum bidding price, target parameters selected by a source of the digital content item, indication of the digital content item being static or dynamic, and the like.

With continued reference to FIG. 1, the server 118 is further coupled to a user profile database 128 via a dedicated link (not numbered). In alternative non-limiting embodiments of the present technology, the user profile database 128 may be communicatively coupled to the server 118 via the communication network 114. Although the user profile database 128 is illustrated schematically herein as a single entity, it is contemplated that the user profile database 128 may be configured in a distributed manner.

Generally speaking, the user profile database 128 is a repository of one or more user profiles (not illustrated). How the one or more user profiles are implemented is not limited, and may for example be a set of vectors representing the interests of a given user.

### User Profile Database 128

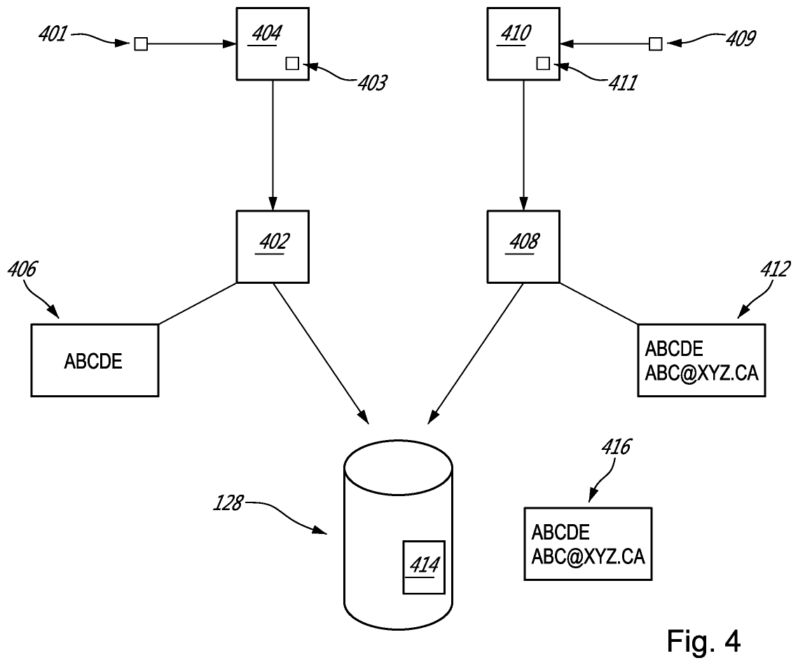

With reference to FIG. 4, a schematic illustration of a process for the aggregation of different user interest profiles associated with the user of the electronic device 102 is depicted.

A first profile 402 is received from a first service server 404. For example, the first service server 404 may be associated with a first service application 401 that corresponds to Yandex.Browser™, which is operated by the same entity providing the aforementioned navigation application 108. The first profile 402 may be generated by the first service server 404 based on the browsing logs 403 associated with the electronic device 102.

The first profile 402 is associated with a first set of unique IDs 406. For example, the first set of unique IDs 406 may include a proprietary user ID assigned to the electronic device 102 by the first service application 401. Recalling that the first service application 401 is operated by the same entity providing the aforementioned navigation application 108, the first set of unique IDs 406 comprises the user device ID 206 (corresponding to “ABCDE”).

A second profile 408 is received from a second service server 410. For example, the second service server 410 may be associated with a second service application 409 that corresponds to Yandex.Market™, which is operated by the same entity providing the aforementioned navigation application 108. The second profile 408 may be generated by the second service server 410 based on search logs 411 associated with the electronic device 102.

The second profile 408 is also associated with a second set of unique IDs 412. Recalling that the second service application 409 is operated by the same entity providing the aforementioned navigation application, the second set of unique IDs 412 comprises the user device ID 206 (“ABCDE”). Additionally, the second set of unique IDs 412 may also comprise the email address of the user used for sign-in (“ABC@XYZ.CA”). In some non-limiting embodiments, the second profile 408 further comprises a public profile picture (not depicted) of the user associated with the electronic device 102.

In some non-limiting embodiments, if the second service application 409 has been accessed by the same user but on another device than the electronic device 102, the second set of unique IDs 412 further comprises another proprietary device ID (not shown) assigned to the other device.

The user profile database 128 is configured to execute a profile aggregation routine (not depicted). The profile aggregation routine is configured to determine if the first profile 402 and the second profile 408 correspond to the same user. For example, the profile aggregation routine may be configured to determine if the first set of unique IDs 406 corresponds, at least partially, to the second set of unique IDs 412.

If it is determined that the first set of unique IDs 406 corresponds at least partially to the second set of unique IDs 412, the profile aggregation routine is configured to aggregate the first profile 402 and the second profile 408 to generate an aggregated user profile 414.

As a result of the execution of the profile aggregation routine, the user profile database 128 stores the aggregated user profile 414 together with a list of associated unique IDs 416 (which comprises the user device ID 206 and the email address), and if present, with the profile picture of the associated user.

On the other hand, if the profile aggregation routine determines that the first set of unique IDs 406 does not correspond even partially to the second set of unique IDs 412, the first profile 402 and the second profile 408 are considered to be associated with different users. Consequently the user profile database 128 stores the first profile 402 (and the first set of unique IDs 406) and the second profile 408 (and the second set of unique IDs 412) separately.

Needless to say, although only two user profiles (the first profile 402 and the second profile 408) are illustrated to generate the aggregated user profile 414, it should be understood that the aggregated user profile 414 may be generated based on more than two user profiles.

Moreover, although the aggregated user profile 414 has been generated based solely on service applications that are operated by the same entity, it is not limited as such. Given that the second profile 408 includes the email address associated with the user, it is possible to further aggregate the user's profile with a third user profile (not shown) that is received from a different entity, provided that the third user profile is also associated with a unique ID that corresponds to the same email address as the one included within the list of associated unique IDs 416.

With continued reference to FIG. 1, the server 118 is further coupled to a content display device 130. The content display device 130 is configured to receive a digital content item (such as the first digital content item 308) for display by the selection application 124, and as such comprises a display screen 132.

How the content display device 130 is implemented is not limited, and may for example, be implemented as an outdoor advertising structure, such as an electronic billboard placed near a highway or a bus stop, or as an indoor advertising structure, such as an electronic billboard within a metro station or within a store.

Depending on the intended use location, the implementation of the content display device 130 will differ. In those non-limiting embodiments where the content display device 130 is implemented indoor, such as in a mall or a store, the content display device 130 may comprise a sensor 134 and a camera 136.

The sensor 134 is configured to detect wireless signals from one or more electronic devices (e.g. WiFi enabled devices, cellular phones, Bluetooth enabled devices, etc.) when located in the range of the sensor 134, and collect the following data for each detected signal: a Media Access Control (MAC) address(es), signal strength, time of detection and unique identifier (if different than the MAC address). An example of collecting the data for each detected signal is disclosed in U.S. Pat. No. 8,699,370 entitled METHOD AND APPARATUS FOR ANALYSIS OF USER TRAFFIC WITHIN A PREDEFINED AREA issued Apr. 15, 2014, the content of which is incorporated by reference herein in its entirety. Although in the depicted embodiment, only one sensor 134 is present, it is not limited as such, and may include more than one sensor. In some non-limiting embodiments, the sensor 134 is implemented as a router enabling WiFi connection between one or more electronic devices and the communication network 114.

How the camera 136 is implemented is not limited. For example, the camera 136 can include an optical sensor (e.g. a charged coupled device (CCD), or a complementary metal-oxide semiconductor (CMOS) image sensor), to facilitate camera functions, such as recording photographs and video clips. Even though in the depicted embodiment, only the camera 136 is present, in alternative embodiments, more cameras can be implemented.

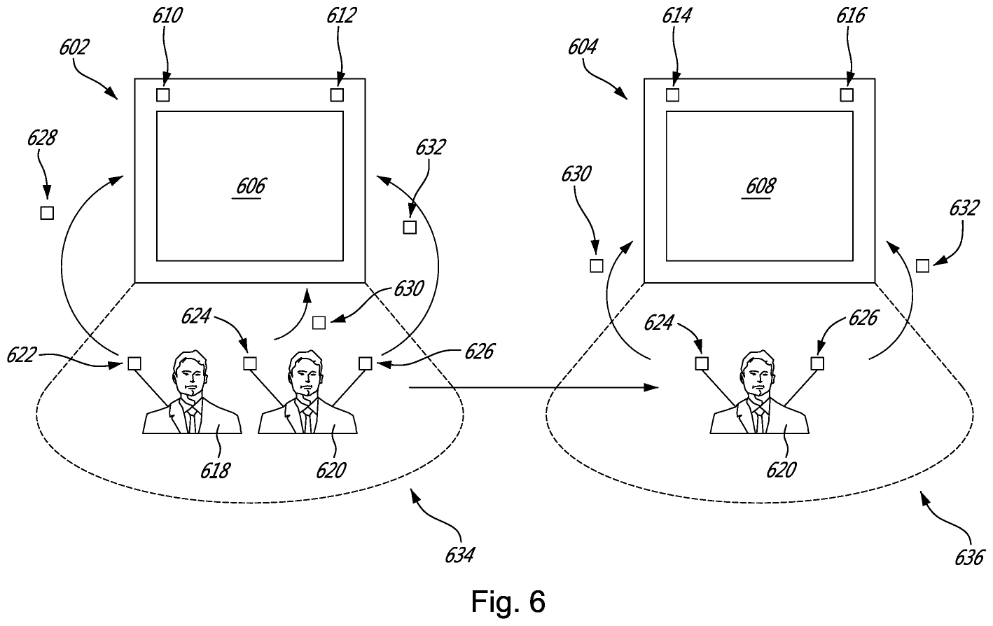

With reference to FIG. 6, a schematic illustration of indoor electronic displays being implemented in accordance with embodiments of the present technology is depicted.

As shown, a first content display device 602 and a second content display device 604 are installed within a building, such as inside a mall, a shop, and the like. The first content display device 602 comprises a first display screen 606, a first sensor 610 and a first camera 612. The second content display device 604 comprises a second display screen 608, a second sensor 614 and a second camera 616.

The first content display device 602 and second content display device 604 is associated with a first exposure perimeter 634 and a second exposure perimeter 636, respectively. The first exposure perimeter 634 and the second exposure perimeter 636 may correspond to an area to which the first display screen 606 and the second display screen 608, respectively, is clearly visible. The manner in which the first exposure perimeter 634 and the second exposure perimeter 636 are determined is not limited, and may depend on the dimensions of the first display screen 606 and the second display screen 608.

Now, in front of the first display screen 606, there is a first user 618 and a second user 620. The first user 618 carries a first electronic device 622 (such as a cell phone). The second user 620 carries a second electronic device 624 (such as a cell phone) and a third electronic device 626 (such as a tablet). Needless to say, it is contemplated that more or fewer users may be in front of the first display screen 606, and more or fewer electronic devices may be carried by the first user 618 and the second user 620.

As described above the first sensor 610 is configured to detect the first electronic device 622, the second electronic device 624 and the third electronic device 626. More precisely, the first sensor 610 is configured to collect a first identifier 628 associated with the first electronic device 622, a second identifier 630 associated with the second electronic device 624, and a third identifier 632 associated with the third electronic device 626. For example, the first identifier 628 may comprise the unique identifier (such as the MAC address) of the first electronic device 622, the signal strength, and the time of the detection.

In some non-limiting embodiments, the sensor 610 is configured to enable two-way communication with the communication network 114 for the first electronic device 622, the second electronic device 624 and the third electronic device 626. In such non-limiting embodiments, the sensor 610 is further configured to assign an IP address to each of the first electronic device 622, the second electronic device 624 and the third electronic device 626.

The first sensor 610 is further configured to periodically detect the signals of the first electronic device 622, the second electronic device 624 and the third electronic device 626.

In some non-limiting embodiments of the present technology, the first camera 612 is configured to take a first picture (not depicted) of the first exposure perimeter 634, where the first user 618 and the second user 620 are located, in response to the first sensor 610 detecting the first electronic device 622, the second electronic device 624 and the third electronic device 626.

In some non-limiting embodiments of the present technology, the first camera 612 is coupled to a movement sensor configured to detect movement within the first exposure perimeter 634, and is configured to take the first picture of the first exposure perimeter 634 in response to the movement sensor detecting movement within the first exposure perimeter 634.

In some non-limiting embodiments of the present technology, the first camera 612 is configured to take the first picture in response to a request by the selection application 124. For example, the selection application 124 may request the first camera 612 to take the first picture prior to transmitting the digital content item (such as the first digital content item 308) for display, at the beginning of the display of the digital content item, during the display of the digital content item, and right after the display of the digital content item.

At a point in time after, the second sensor 614 detects the second electronic device 624 and the third electronic device 626, and as such is configured to collect the second identifier 630 and the third identifier 632. The second camera 616 is then configured to take a second picture (not depicted) of the second exposure perimeter 636 which comprises the second user 620, and transmit the second picture, second identifier 630 and the third identifier 632 to the selection application 124. Needless to say, how and when the second camera 616 is configured to take the second picture is not limited, and may for example be implemented similar to the first camera 612.

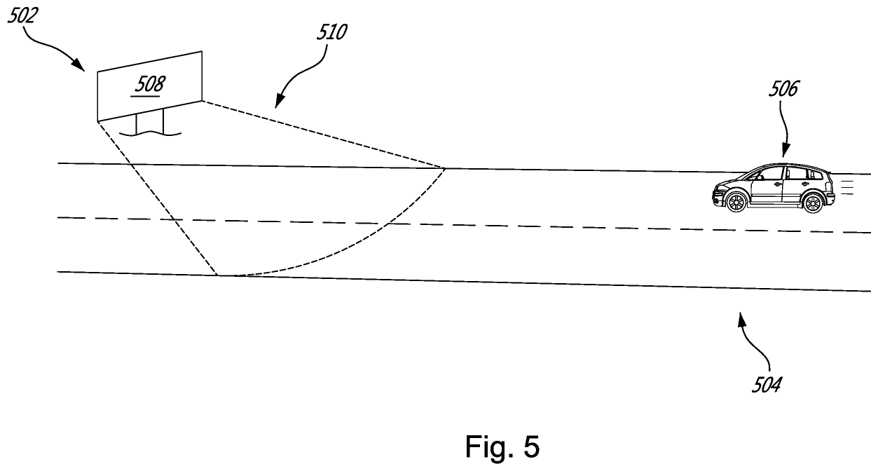

With reference to FIG. 5, a schematic illustration of an outdoor electronic billboard being implemented in accordance with embodiments of the present technology is depicted.

As shown, a content display device 502 is installed in proximity to a road 504 on which a user associated with the electronic device 102 (not shown) driving a vehicle 506 is travelling. The content display device 502 comprises a display screen 508, on which the digital content item (such as the first digital content item 308) selected by the selection application 124 is displayed.

In some non-limiting embodiments of the present technology, the display screen 508 is associated with an exposure perimeter 510. The exposure perimeter 510 may correspond to the area to which the display screen 508 is clearly visible. The manner in which the exposure perimeter 510 is determined is not limited and may depend on the dimensions of the display screen 508, and/or the presence of obstacles (such as buildings) nearby.

### Selection Application 124

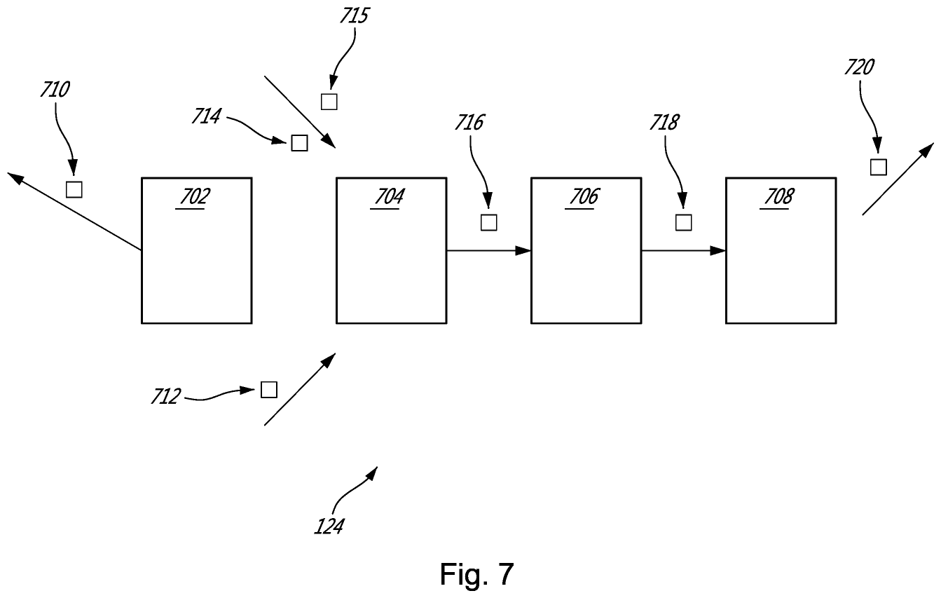

With reference to FIG. 7, there is provided a schematic illustration of the selection application 124 being implemented in accordance with non-limiting embodiments of the present technology. The selection application 124 executes (or otherwise has access to): a first content selection routine 702, a receiving routine 704, a localization routine 706 and a second content selection routine 708.

In the context of the present specification, the term “routine” refers to a subset of the computer executable program instructions of the selection application 124 that is executable by the server processor 122 to perform the functions explained below in association with the various routines (the first content selection routine 702, the receiving routine 704, the localization routine 706 and the second content selection routine 708). For the avoidance of any doubt, it should be expressly understood that the first content selection routine 702, the receiving routine 704, the localization routine 706 and the second content selection routine 708 are illustrated schematically herein as separate entities for ease of explanation of the processes executed b the selection application 124. It is contemplated that some or all of the first content selection routine 702, the receiving routine 704, the localization routine 706 and the second content selection routine 708 may be implemented as one or more combined routines.

For ease of understanding the present technology, functionality of each one of the first content selection routine 702, the receiving routine 704, the localization routine 706 and the second content selection routine 708, as well as data and/or information processed or stored therein are described below.

Furthermore, for ease of understanding of the current technology, the functionality of each one of the first content selection routine 702, the receiving routine 704, the localization routine 706 and the second content selection routine 708, as well as data and/or information processed or stored therein will be explained below with reference to a first scenario in reference to FIG. 5, and a second scenario in reference to FIG. 6. It should be understood that the scenarios presented herein below is for ease of understanding only, and the present technology is in no way to be limited based on the scenario presented below.

### First Content Selection Routine 702—Scenario 1

The first content selection routine 702 is configured to access the digital content item database 126 and select a digital content item (such as the first digital content item 308). How the first content selection routine 702 selects the first digital content item 308 is not limited. Suffice to say that the first content selection routine 702 selects the first digital content item 308 in a non-user specific manner.

In some non-limiting embodiments of the present technology, the first content selection routine 702 is configured to select the first digital content item 308 in a user-specific manner, or a group-specific manner. An example of selecting the first digital content item 308 in a user-specific manner and/or group-specific manner is disclosed in a co-owned U.S. Patent Application bearing attorney docket number 40703-127 entitled METHOD AND SYSTEM FOR PROVIDING A DIGITAL CONTENT ITEM TO AN ELECTRONIC DEVICE, the content of which is incorporated by reference herein in its entirety. As such, the first content selection routine 702 may be configured to receive a data packet (not shown) indicative of one or more electronic devices nearby the content display device 502 prior to selecting the first digital content items 308.

The first content selection routine 702 is then configured to transmit a data packet 710 to the content display device 502 (see FIG. 5). The data packet 710 comprises the first digital content item 308 to be displayed on the display screen 508.

In some non-limiting embodiments, the data packet 710 further comprises display instructions, such as the duration and time at which the digital content item 308 must be displayed.

### Receiving Routine 704—Scenario 1

After the digital content item 308 has been displayed at least once by the display screen 508, the receiving routine 704 is configured to receive a data packet 712 from the electronic device 102. The data packet 712 comprises the navigation log 110 (see FIG. 2) associated with the electronic device 102.

As discussed briefly above, the navigation log 110 may store the user device ID 206 and a list of GPS positions with respective time stamps that have been collected offline, and/or during use of the navigation application 108. Accordingly, the data packet 712 may be received during the in-use phase of the navigation application 108, or received on a periodical basis, such as every day, every 48 hours, and the like.

In some non-limiting embodiments of the present technology, the receiving routine 704 is configured to transmit a location of the content display device 502 to the electronic device 102 and request a subset of the navigation log 110 which comprise a list of GPS positions with respective time stamps nearby the location.

Based on the navigation log 110, the receiving routine 704 is configured to build a user navigation history, which is indicative of the user movement within a predetermined time period. For example, the user navigation history maybe indicative that the user has travelled via the vehicle 506 on the road 504.

In some non-limiting embodiments of the present technology, the receiving routine 704 is further configured to receive a data packet 714 from the content display device 502. The data packet 714 comprises an indication of the exposure perimeter 510 associated with the content display device 502. Needless to say, it is contemplated that the exposure perimeter 510 can be stored within the server 118 instead.

As has been alluded to above, it is contemplated that a given user may be travelling with more than one electronic device that is configured to collect and generate a respective navigation log. As such, in some non-limiting embodiments of the present technology, the receiving routine 704 is configured to correlate one or more navigation logs and based on the GPS positions and time stamps over a period of time to determine if the electronic devices are carried by the same user.

### Localization Routine 706—Scenario 1

Once the user navigation history has been built, the receiving routine 704 is configured to transmit a data packet 716 to the localization routine 706. The data packet 716 comprises the user navigation history, the exposure perimeter 510, and the user device ID 206 (which was previously provided within the navigation log 110).

The localization routine 706 is configured to execute the following functions. First, the localization routine 706 is configured to determine if the user navigation history is indicative of the given user having been exposed to the first digital content item 308. For example, the localization routine 706 may be configured to determine if any of the navigated positions correlate with the exposure perimeter 510 during the relevant time (i.e. the duration of the first digital content item 308) and for a pre-determined minimum amount of time (to be considered to have been exposed).

In some of the non-limiting embodiments of the present technology, the localization routine 706 is configured to apply a set of heuristic rules to determine a likelihood parameter that is indicative of the user having been exposed to the first digital content item 308. Just as a non-limiting example, the set of heuristic rules may include one or more of the following determinations:
Whether at the time the user has been in the exposure perimeter 510, the first digital content item 308 was being displayed by the content display device 502;
The dwelling time of the user in the exposure perimeter 510;
The velocity of the user when passing through the exposure perimeter 510;
A length of time of the first digital content item 308 being displayed by the content display device 502; and
Whether the user has decreased the velocity prior to arriving within the exposure perimeter 510 or within the exposure perimeter 510.

How the likelihood parameter is implemented is not limited, and may for example be implemented as a percentage value, a range value (i.e. from 1 to 10), or as a binary value.

The localization routine 706 is further configured to compare the likelihood parameter against a threshold value. The manner in which the threshold value is determined is not limited, and may for example be determined empirically. Furthermore, how the threshold value is implemented is not limited, and will depend on how the likelihood parameter is implemented.

### Second Content Selection Routine 708—Scenario 1

In response to the likelihood parameter being above the threshold value, the localization routine 706 is configured to transmit a data packet 718 to the second content selection routine 708. The data packet 718 comprises an indication of the likelihood parameter being above the threshold value, as well as the user device ID 206.

The second content selection routine 708 is configured to execute the following functions. First, the second content selection routine 708 is configured to access the user profile database 128 and retrieve the aggregated user profile 414 based on the user device ID 206. Once retrieved, the second content selection routine 708 is configured to determine if the topic associated with the first digital content item 308 is aligned with the aggregated user profile 414. For example, assuming that the first digital content item 308 is an advertisement for the 2018 Toyota car models, and the aggregated user profile 414 is indicative of a general interest in cars, it is determined that the first digital content item 308 is aligned with the aggregated user profile 414.

If it is determined that the first digital content item 308 is aligned with the aggregated user profile 414, the second content selection routine 708 is configured to access the digital content item database 126 and retrieve the second digital content item 312 that is also stored within the first topic cluster 304.

The second content selection routine 708 is further configured to transmit a data packet 720 to the service servers (such as the first service server 404 and the second service server 410, see FIG. 4). The data packet 720 comprises the second digital content item 312 and instructions to display the second digital content item 312 when the user accesses one of the associated service applications (such as the first service application 401 and the second service application 409).

If on the other hand, the first digital content item 308 is not aligned with the aggregated user profile 414, the second content selection routine 708 is configured to update the aggregated user profile 414 to reflect the interest of the user to the first digital content item 308.

Turning now to FIG. 6, the functionality of each one of the first content selection routine 702, the receiving routine 704, the localization routine 706 and the second content selection routine 708, as well as data and/or information processed or stored therein will be explained below with reference to the second scenario in reference to FIG. 6.

For simplicity, elements or functions of the Scenario 2 have been labelled with the same reference numerals. New elements or functions not disclosed within the Scenario 1 have been labelled with additional reference numerals. It should be understood that some elements or functions performed under Scenario 1 is not similarly performed in Scenario 2 and vice-versa.

### First Content Selection Routine 702—Scenario 2

The first content selection routine 702 is configured to access the digital content item database 126 and select a digital content item (such as the first digital content item 308). How the first content selection routine 702 selects the first digital content item 308 is not limited. Suffice to say that the first content selection routine 702 may select the first digital content item 308 in a similar manner as disclosed with regards to the Scenario 1 above.

The first content selection routine 702 is then configured to transmit a data packet 710 to the first content display device 602. The data packet 710 comprises the first digital content item 308 to be displayed on the first display screen 606.

In some non-limiting embodiments, the data packet 710 further comprises display instructions, such as the time at which the digital content item 308 must be displayed.

### Receiving Routine 704—Scenario 2

After the digital content item 308 has been displayed at least once, the receiving routine 704 is configured to receive a data packet 712 from the electronic device 102. The data packet 712 comprises the navigation log 110 (see FIG. 2) associated with the electronic device 102.

As discussed briefly above, the navigation log 110 may comprise the user device ID 206 and a list of GPS positions and respective time stamps that have been collected offline, and/or during use of the navigation application 108. Accordingly, the data packet 712 may be received during the in-use phase of the navigation application 108, or received on a periodical basis, such as every day, every 48 hours, and the like.

In some non-limiting embodiments, the receiving routine 704 is configured to transmit a location of the content display device 502 to the electronic device 102 and request a subset of the navigation log 110 which comprise a list of GPS positions with respective time stamps nearby the location.

Based on the navigation log 110, the receiving routine 704 is configured to build a user navigation history, which is indicative of the user movement within a predetermined time period. For example, the user navigation history maybe indicative that the user has travelled within a building which comprises the first content display device 602.

If the user navigation history is indicative that the user has travelled within the building comprising the first content display device 602, the receiving routine 704 is further configured to receive a data packet 714 from the first content display device 602.

The data packet 714 comprises an indication of the first exposure perimeter 634, a first captured image (not depicted) taken at the start of the displaying of the first digital content item 308, a second captured image (not depicted) taken at the end of the displaying of the first digital content item 308, and one or more identifiers (such as the first identifier 628, the second identifier 630 and the third identifier 632, see FIG. 6) collected while the first digital content item 308 has been displayed. Needless to say, it is contemplated that the first exposure perimeter 634 be stored within the server 118 instead.

### Localization Routine 706—Scenario 2

Once the user navigation history has been built, the receiving routine 704 is configured to transmit a data packet 716 to the localization routine 706. The data packet 716 comprises the user navigation history, the user device ID 206, as well as the information contained within the data packet 714.

Now based on the information contained within the data packet 714, the localization routine 706 is configured to augment the user navigation history (described below). Developers have assumed that although the user navigation history may be able to provide a good indication of where the user has travelled, in some situations, such as inside a building, it may not be sufficiently precise to determine if the user has actually navigated within the first exposure perimeter 634. For example, it may be that the first content display device 602 is provided on a second floor of the building, which would make the determination imprecise if the user navigation history is used. The localization routine 706 is then configured to determine a likelihood parameter of the user having been exposed to the first digital content item 308 based on the augmented user navigation history.

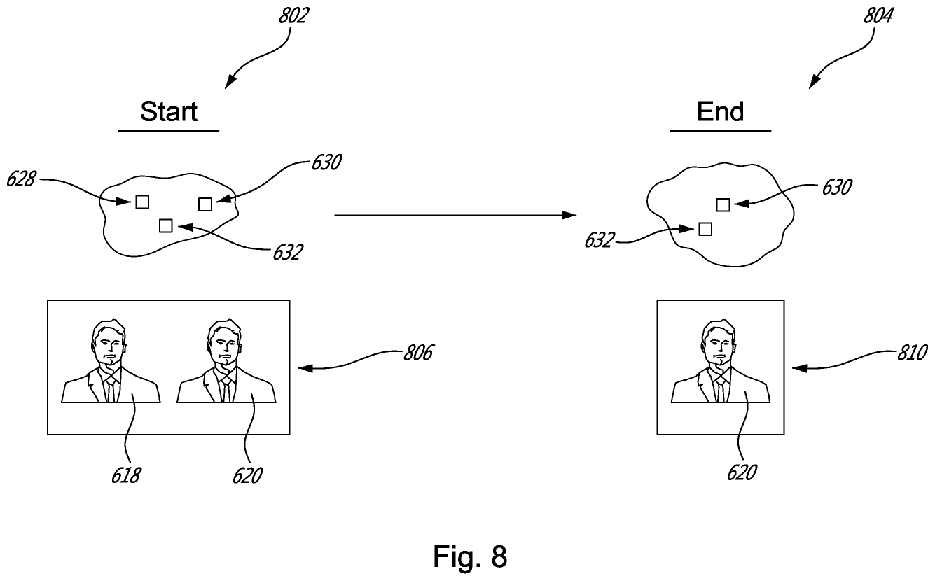

With reference to FIG. 8, a schematic illustration on how the user navigation history is augmented and how the likelihood parameter is determined are depicted.

Let us assume that at a starting time 802 of the displaying of the first digital content item 308, a first image 806 has been captured. The first image 806 comprises the first user 618 and the second user 620. Furthermore, within a predetermined time period from the start of the displaying of the first digital content item 308, the first sensor 610 has collected the first identifier 628, the second identifier 630 and the third identifier 632.

At an ending time 804 of the displaying of the first digital content item 308, a second image 810 has been captured. The second image 810 comprises the second user 620 only. Furthermore, within a predetermined time period from the end of the displaying of the first digital content item 308, the first sensor 610 has collected the second identifier 630 and the third identifier 632.

Based on a deduction analysis, the localization routine 706 is configured to determine that the first user 618 is associated with the first identifier 628, while the second user 620 is associated with the second identifier 630 and the third identifier 632.

The localization routine 706 is further configured to execute a face recognition application (not shown). The face recognition application is configured to access the user profile database 128, and determine if the face of the second user 620 captured by the second image 810 is associated with a user profile. How the face recognition application is implemented is generally known in the art, and will not be descripted herein.

Assuming that the profile picture (not depicted) that is associated with the aggregated user profile 414 (see FIG. 4) corresponds to the face of the second user 620 captured in the second image 810, the localization routine 706 is configured to associate the aggregated user profile 414 with the second user 620.

Having associated the aggregated user profile 414 and the second user 620, the localization routine 706 is configured to augment the user navigation history. More precisely, the localization routine 706 is configured to determine if the user device ID 206 corresponds to one of the unique ID included within the list of associated unique IDs 416 (see FIG. 4). In the affirmative, the user navigation history is updated with the determination made by the localization routine 706, such as the floor on which the user has travelled, distance between the first display screen and the user (based on the signal strengths), dwelling time, direction of movement of the user, and the like.

Needless to say, it is contemplated that the aggregated user profile 414 and the second user 620 are associated by other means, such as described in a co-owned U.S. Patent Application attorney docket number 40703-127 entitled METHOD AND SYSTEM FOR PROVIDING RECOMMENDED DIGITAL ITEM TO ELECTRONIC DEVICE, the content of which is incorporated herein in its entirety.

Having associated the aggregated user profile 414 with the second user 620, the localization routine 706 is configured to determine the likelihood parameter of the user having been exposed to the digital content item 308 based on the augmented user navigation history.

The localization routine 706 is configured to apply a set of heuristic rules to determine the likelihood parameter. Just as a non-limiting example, the set of heuristic rules may include one or more of the following determinations:
Whether the collected signal strengths are indicative of the second user 620 being close to the first content display device 602;
Whether the first image 806 and the second image 810 are indicative of the second user 620 looking at the first display screen 606; and
Whether the user has been presented nearby the first content display device for the duration of the displaying of the first digital content item 308.

How the likelihood parameter is implemented is not limited, and may for example be implemented as a percentage value, a range value (i.e. from 1 to 10), or as a binary value.

The localization routine 706 is further configured to compare the likelihood parameter against a threshold value. The manner in which the threshold value is determined is not limited, and may for example be determined empirically. Furthermore, how the threshold value is implemented is not limited, and will depend on how the likelihood parameter is implemented.

Now, although in the example, only the second user 620 has been present at the ending time 804, it is possible that in some scenario, both the first user 618 and the second user 620 are still present at the ending time 804, which prevents the localization routine 706 from associating the aggregated user profile 414 to the second user 620.

In such situations, the localization routine 706 is configured to wait until it receives a data packet 715 which contains a picture of a single person, as well as the identifiers corresponding to the one or more identifiers previously received within the data packet 714. For example, the localization routine 706 may receive the data packet 715 from the second content display device 604, which comprises at least a third image (not depicted), and the second identifier 630 and the third identifier 632 collected by the second sensor 614 (see FIG. 6).

By the deduction analysis, the localization routine 706 is then configured to associate the aggregated user profile 414 to the second user 620 (as well as associating another aggregated user profile to the first user 618), and determine a respective likelihood parameter to the first user 618 and the second user 620.

### Second Content Selection Routine 708—Scenario 2

In response to the likelihood parameter being above the threshold value, the localization routine 706 is configured to transmit a data packet 718 to the second content selection routine 708. The data packet 718 comprises an indication of the likelihood parameter being above the threshold value, as well as the aggregated user profile 414.

The second content selection routine 708 is configured to execute the following functions. First, the second content selection routine 708 is configured to access the user profile database 128 and determine if the topic associated with the first digital content item 308 is aligned with the aggregated user profile 414.

If it is determined that the first digital content item 308 is aligned with the aggregated user profile 414, the second content selection routine 708 is configured to access the digital content item database 126 and retrieve the second digital content item 312 that is also stored within the first topic cluster 304.

The second content selection routine 708 is further configured to transmit a data packet 720 to the service servers (such as the first service server 404 and the second service server 410, see FIG. 4). The data packet 720 comprises the second digital content item 312 instructions to display the second digital content item 312 as a recommended digital content item when the user accesses one of the associated service applications (such as the first service application 401 and the second service application 409) using the electronic device 102.

If on the other hand, the first digital content item 308 is not aligned with the aggregated user profile 414, the second content selection routine 708 is configured to update the aggregated user profile 414 to reflect the interest of the user to the first digital content item 308.

The various non-limiting embodiments of the present technology may allow proper determination of the exposure of a digital content item to a user in an offline setting, thereby allowing proper selection of further digital content item in an online setting.

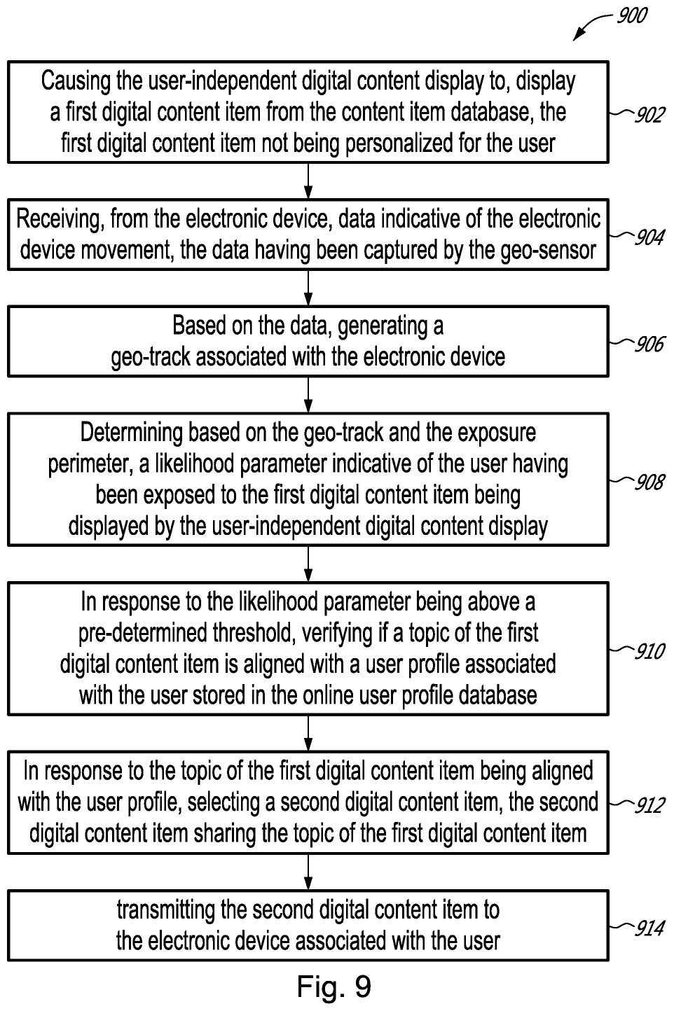

Given the architecture and examples provided hereinabove, it is possible to execute a computer-implemented method for providing a recommended content item. With reference to FIG. 9, there is depicted a flow chart of a method 900 for providing the recommended content item. The method 900 being executable in accordance with non-limiting embodiments of the present technology. The method 900 can be executed by the server 118.

Step 902: causing the user-independent digital content display, to display a first digital content item from the content item database, the first digital content item not being personalized for the user

The method 900 will be explained below with reference to two scenarios. It should be understood that the scenario presented herein below are for illustration purposes only, and the present technology is no way to be limited based on the scenarios presented below.

The method 900 starts at step 902, where the first content selection routine 702 accesses the digital content item database 126 and selects a digital content item to be displayed on the display screen 132.

Scenario 1: The first content selection routine 702 transmits the data packet 710 to the content display device 502 (see FIG. 5). The data packet 710 comprises the first digital content item 308 to be displayed on the display screen 508.

Scenario 2: The first content selection routine 702 transmits the data packet 710 to the first content display device 602 (see FIG. 6). The data packet 710 comprises the first digital content item 308 to be displayed on the first display screen 606.

Step 904: receiving, from the electronic device, data indicative of the electronic device movement, the data having been captured by the geo-sensor

At step 904, after the digital content item 308 has been displayed at least once, the receiving routine 704 is configured to receive from the electronic device 102, data indicative of the movement of the electronic device 102.

Scenario 1 and Scenario 2: The receiving routine 704 receives the data packet 712 from the electronic device 102, which comprises the navigation log 110 (see FIG. 2) associated with the electronic device 102.

Step 906: based on the data, generating a geo-track associated with the electronic device

At step 906, based at least on the navigation log 110, the receiving routine 704 is configured to build the user navigation history, indicative of the movement of the electronic device 102.

Scenario 1: Based on the navigation log 110, the receiving routine 704 is configured to build the user navigation history, which may for example be indicative that the user was travelling on the road 504 (see FIG. 5).

In some non-limiting embodiments, the receiving routine 704 is further configured to receive the data packet 714 from the content display device 502. The data packet 714 comprises an indication of the exposure perimeter 510 associated with the content display device 502.

Scenario 2: Based on the navigation log 110, the receiving routine 704 is configured to build the user navigation history, which may for example be indicative that the user entered a building which comprises the first content display device 602.

If the user navigation history is indicative that the user has travelled within the building comprising the first content display device 602, the receiving routine 704 is further configured to receive the data packet 714 from the first content display device 602.

The data packet 714 comprises an indication of the first exposure perimeter 634, a first captured image (not depicted) taken at the start of the displaying of the first digital content item 308, a second captured image (not depicted) taken at the end of the displaying of the first digital content item 308, and one or more identifiers (such as the first identifier 628, the second identifier 630 and the third identifier 632, see FIG. 6) collected while the first digital content item 308 has been displayed.

Step 908: determining based on the geo-track and the exposure perimeter, a likelihood parameter indicative of the user having been exposed to the first digital content item being displayed by the user-independent digital content display

At step 908, the receiving routine 704 is configured to transmit the data packet 716 to the localization routine 706. The data packet 716 comprises data for the localization routine 706 to determine the likelihood parameter of the user associated with the electronic device 102 to have been exposed to the first digital content item 308.

Scenario 1: Once the user navigation history has been built, the receiving routine 704 is configured to transmit the data packet 716 to the localization routine 706. The data packet 716 comprises the user navigation history, the exposure perimeter 510, and the user device ID 206 (which was provided within the navigation log 110 previously).

The localization routine 706 is configured to determine if any of the navigated positions correlate with the exposure perimeter 510 during the displaying of the first digital content item 308 and for a pre-determined minimum amount of time.

In some of the non-limiting embodiments of the present technology, the localization routine 706 is configured to apply a set of heuristic rules to determine a likelihood parameter that is indicative of the user having been exposed to the first digital content item 308.

Scenario 2: Once the user navigation history has been built, the receiving routine 704 is configured to transmit the data packet 716 to the localization routine 706. The data packet 716 comprises the user navigation history, the user device ID 206, as well as the information contained within the data packet 714.

Now based on the information contained within the data packet 714, the localization routine 706 is configured to augment the user navigation history and determine a likelihood parameter of the user having been exposed to the first digital content item 308.

More precisely, the localization routine 706 is configured to associate the collected one or more identifiers (such as the second identifier 630 and the third identifier 632, see FIG. 6) during the displaying of the first digital content item 308, with the face of the user captured by the first image 806 and the second image 810 (see FIG. 8).

The localization routine 706 is configured to execute the face recognition application (not shown). The face recognition application is configured to access the user profile database 128, and determine that the face of the second user 620 is associated with the aggregated user profile 414.

Having associated the aggregated user profile 414 and the second user 620, the localization routine 706 is configured to augment the user navigation history. More precisely, the localization routine 706 is configured to determine if the user device ID 206 corresponds to one of the IDs included within the list of associated unique IDs 416 (see FIG. 4). In the affirmative, the user navigation history is updated with the determination made by the localization routine 706.

Based on the augmented user navigation history, the localization routine 706 is configured to determine the likelihood parameter of the user having been exposed to the digital content item 308, by applying a set of heuristic rules.

Step 910: in response to the likelihood parameter being above a pre-determined threshold, verifying if a topic of the first digital content item is aligned with a user profile associated with the user stored in the online user profile database

At step 910, the localization routine 706 is configured to compare the likelihood parameter against a threshold value, and verify if the topic of the first digital content item 308 is aligned with the aggregated user profile 414.

Scenario 1: In response to the likelihood parameter being above the threshold value, the localization routine 706 is configured to transmit the data packet 718 to the second content selection routine 708. The data packet 718 comprises an indication of the likelihood parameter is above the threshold value, as well as the user device ID 206

The second content selection routine 708 is configured to execute the following functions. First, the second content selection routine 708 is configured to access the user profile database 128 and retrieve the aggregated user profile 414 based on the user device ID 206. Once retrieved, the second content selection routine 708 is configured to determine if the topic associated with the first digital content item 308 is aligned with the aggregated user profile 414.

Scenario 2: In response to the likelihood parameter being above the threshold value, the localization routine 706 is configured to transmit the data packet 718 to the second content selection routine 708. The data packet 718 comprises an indication of the likelihood parameter is above the threshold value, as well as the aggregated user profile 414.

The second content selection routine 708 is configured to access the user profile database 128 and determine if the topic associated with the first digital content item 308 is aligned with the aggregated user profile 414.

Step 912: in response to the topic of the first digital content item being aligned with the user profile, selecting a second digital content item, the second digital content item sharing the topic of the first digital content item

Scenario 1 & 2: At step 912, if it is determined that the first digital content item 308 is aligned with the aggregated user profile 414, the second content selection routine 708 is configured to access the digital content item database 126 and retrieve the second digital content item 312 that is also stored within the first topic cluster 304.

Step 914: transmitting the second digital content item to the electronic device associated with the user

Scenario 1 & 2: At step 914, the second content selection routine 708 is further configured to transmit the data packet 720 to the service servers (such as the first service server 404 and the second service server 410, see FIG. 4). The data packet 720 comprises the second digital content item 312 instructions to display the second digital content item 312 as a recommended digital content item when the user accesses one of the associated service applications (such as the first service application 401 and the second service application 409) using the electronic device 102.

It should be apparent to those skilled in the art that at least some embodiments of the present technology aim to expand a range of technical solutions for addressing a particular technical problem encountered by the conventional content item recommendation services, namely determining exposure to offline advertisements and providing for display additional content items on topics that the user may desire to obtain.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A computer-implemented method for providing a recommended content item to an electronic device associated with a user, the electronic device having a geo-sensor, the method being executed by a server coupled to:
an online user profile database maintaining one or more online user profiles of one or more users associated with one or more services;
a user-independent digital content display having an exposure perimeter;
a content item database comprising a plurality of digital content items;
the method comprising:
causing the user-independent digital content display, to display a first digital content item from the content item database, the first digital content item not being personalized for the user;
receiving, from the electronic device, data indicative of the electronic device movement, the data having been captured by the geo-sensor;
based on the data, generating a geo-track associated with the electronic device;
determining based on the geo-track and the exposure perimeter, a likelihood parameter indicative of the user having been exposed to the first digital content item being displayed by the user-independent digital content display;
in response to the likelihood parameter being above a pre-determined threshold, verifying if a topic of the first digital content item is aligned with a user profile associated with the user stored in the online user profile database;
in response to the topic of the first digital content item being aligned with the user profile, selecting a second digital content item, the second digital content item sharing the topic of the first digital content item; and
transmitting the second digital content item to the electronic device associated with the user.

2. The method of claim 1, wherein the user-independent digital content display comprises at least one sensor, and wherein the likelihood parameter is further based on the at least one sensor detecting the electronic device being within the exposure perimeter.

3. The method of claim 2, wherein the at least one sensor is configured to detect a unique device identifier and a signal strength associated with the electronic device.

4. The method of claim 1, wherein the geo-sensor is a GPS sensor, and wherein the likelihood parameter is further based on a GPS-based position of the GPS sensor being within the exposure perimeter.

5. The method of claim 4, wherein the geo-track comprises a trajectory and dwelling intervals associated with movement of the electronic device, and wherein the likelihood parameter is further based on at least one of:
the trajectory intersecting the exposure perimeter;
the dwelling intervals being proximate to the exposure perimeter.

6. The method of claim 5, wherein the likelihood parameter being above the pre-determined threshold in response to the dwelling intervals being above a pre-determined duration.

7. The method of claim 1, wherein the electronic device comprises a user ID and wherein the method further comprises acquiring the user profile based on the user ID.

8. The method of claim 1, wherein the electronic device comprises a device ID and wherein the method further comprises correlating the device ID with a user ID, and acquiring the user profile based on the user ID.

9. The method of claim 2, wherein
the user-independent digital content display further comprises a camera; and wherein the method further comprises:
receiving, the user-independent digital content display, a captured image of the user;
correlating the captured image to the user profile.

10. The method of claim 9, wherein the correlating the captured image to the user profile comprises:
accessing the one or more web services;
matching the captured image with digital images contained in open pages associated with the user.

11. The method of claim 1, wherein the user-independent digital content display is one an electronic billboard and an electronic screen.

12. The method of claim 1, wherein the receiving, from the electronic device, data indicative of the electronic device movement, the data having been captured by the geo-sensor comprises:
receiving data from multiple electronic devices;
correlating data from multiple electronic devices to the user based on geo information from the multiple electronic devices being aligned over a pre-determined period of time.

13. A system for providing a recommended content item to an electronic device associated with a user, the electronic device having a geo-sensor, the system comprising a server connectable to:
an online user profile database maintaining one or more online user profiles of one or more users associated with one or more services;
a user-independent digital content display having an exposure perimeter;
a content item database comprising a plurality of digital content items;
the server comprising a processor configured to:
cause the user-independent digital content display, to display a first digital content item from the content item database, the first digital content item not being personalized for the user;
receive, from the electronic device, data indicative of the electronic device movement, the data having been captured by the geo-sensor;
based on the data, generate a geo-track associated with the electronic device;
determine based on the geo-track and the exposure perimeter, a likelihood parameter indicative of the user having been exposed to the first digital content item being displayed by the user-independent digital content display;
in response to the likelihood parameter being above a pre-determined threshold, verify if a topic of the first digital content item is aligned with a user profile associated with the user stored in the online user profile database;
in response to the topic of the first digital content item being aligned with the user profile, select a second digital content item, the second digital content item sharing the topic of the first digital content item; and
transmit the second digital content item to the electronic device associated with the user.

14. The system of claim 13, wherein the user-independent digital content display comprises at least one sensor, and wherein the likelihood parameter is further based on the at least one sensor detecting the electronic device being within the exposure perimeter.

15. The system of claim 14, wherein the at least one sensor is configured to detect a unique device identifier and a signal strength associated with the electronic device.

16. The system of claim 13, wherein the geo-sensor is a GPS sensor, and wherein the likelihood parameter is further based on a GPS-based position of the GPS sensor being within the exposure perimeter.

17. The system of claim 16, wherein the geo-track comprises a trajectory and dwelling intervals associated with movement of the electronic device, and wherein the likelihood parameter is further based on at least one of:
the trajectory intersecting the exposure perimeter;
the dwelling intervals being proximate to the exposure perimeter.

18. The system of claim 17, wherein the likelihood parameter being above the pre-determined threshold in response to the dwelling intervals being above a pre-determined duration.

19. The system of claim 13, wherein the electronic device comprises a user ID and wherein the processor is further configured to acquire the user profile based on the user ID.

20. The system of claim 14, wherein
the user-independent digital content display further comprises a camera; and wherein the processor is further configured to:
receive, the user-independent digital content display, a captured image of the user,
correlate the captured image to the user profile.
